(19) United States
(12) Patent Application Publication
(10) Pub. No.: US 2005/0093316 A1
(43) Pub. Date: May 5, 2005

(54) Tool handle and method of manufacturing same

(76) Inventor: James O'Rear, Wedowee, AL (US)

Correspondence Address: SMITH, GAMBRELL & RUSSELL, LLP;SUITE 3100, PROMENADE II, 1230 PEACHTREE STREET, N.E., ATLANTA, GA, 30309-3592, US

(21) Appl. No.: 11/002,450

(22) Filed: Dec. 2, 2004

Related U.S. Application Data
(63) Continuation of application No. 10/267,508, filed on Oct. 9, 2002.

(51) Int. Cl. A01B 1/22

(52) U.S. Cl. 294/57

(57) ABSTRACT

A tool handle and a method of producing the same are provided by which a hollow plastic or composite rod is produced with a polymer at least partly filling the hollow portion. Optionally the handle may be counterbalanced by heavier material in the hollow-portion of the rod opposite the end that connects to an implement.

### TECHNICAL FIELD OF THE INVENTION

This invention relates a method for producing tool handles comprised of plastic or composite rods or tubes having hollow interiors which are at least partly filled with a polymer. This invention also relates to an improved tool handle having an integral measuring device along the length of the handle.

### BACKGROUND ART

U.S. Pat. Nos. 2,948,649 and 3,556,888 disclose forming a tube to produce a cured composite. The drawback of this method is that the solid extruded product is unacceptably heavy. One such application is a composite replacement for wooden handles of a shovel.

The weight problem could be alleviated by means of extruding hollow tubes utilizing a die tube with the center filled, leaving an annular cross section through which fibers are pulled. Although this process can produce a light, hollow tube, it has a bending or crushing strength significantly lower than that of a solid rod, and therefore would not be suitable for certain high-stress applications, such as shovel handles.

The bending stress problem can be solved by producing a rod which is hollow throughout most of its length and which is at least partly filled with a polymer to provide the required strength. The current techniques provide no convenient and inexpensive way to produce such a reinforced product. However, in accordance with presently known practices, the reinforced tubing referred to above could be produced in several ways. For example, a solid pultruded rod could be bored out through most of its length, or a hollow pultruded tube could have a solid plug glued into its center for some fraction of its length. The boring method has the disadvantage of wasting material and being time consuming. The plugging method has the additional disadvantage of lowered strength due to the imperfect fit of the plug. Both of these methods would be too costly to provide an economical means of mass producing shovel handles or the like.

Accordingly, there has existed a need for a convenient and effective method for producing a rod with a solid reinforcing and/or hollow cross section.

In using various tools, such as post-hole diggers, shovels, rakes and other such tools, it is often necessary to take a measurement from the work area. For instance, while manually digging a hole, there is a frequent need to measure the depth of the hole during the process of digging. This is necessary to insure that the hole is deep enough for the particular application and at the same time to insure that the hole has not been dug too deeply. Similarly, it is often necessary to measure the depth of, for instance, a gravel bed or the layer of concrete as one is preparing a concrete patio or driveway. As another example, those skilled in the art, are also aware of the need to frequently measure the depth of a trench that is being prepared for a footer. Typically this is done by placing the tool that one is working with on the ground, reaching for a conventional tape measure and taking the measurement. While this by itself is time consuming, with each of the examples recited above, there is also the attendant risk of the tape becoming coated with either mud or concrete and requiring cleaning. Again, this is also time consuming.

It is also common, in the example of digging a hole, for the person digging the hole to cut, or scratch, a notch in the handle. However, while this solves the need to reach for a tape measure, as holes of various depths are dug, the number of notches in the handles can become confusing. It is also possible for the notches to be confused with normal wear on the handles.

U.S. Pat. No. 2,192,399 discloses a tool handle that has a longitudinal groove that has a strip of suitable metal fixed in the bottom of the groove. The strip of metal is graduated to indicate inches and fractions thereof. As disclosed, one or more markers may be pressed into the groove to indicate fixed points of measurement that may be desired. As those skilled in the art have come to recognize, longitudinal grooves can become caked with dirt, mud or concrete making it difficult to read the graduations. Moreover, such a marker requires a handle of a specific configuration, namely having the disclosed longitudinal groove, in order to be used. Further, by placing the graduated strip of metal and the associated markers in a groove, the measurement is only visible when the handle is correctly oriented with reference to the viewer.

### SUMMARY OF THE INVENTION

The present invention resides in a tool handle that is a light hollow rod or tube with an internal reinforced segment as well as a method of producing such a rod or tube. The finished product is lightweight yet relatively strong.

More specifically, the method of the present invention includes the formation of a section of tubing or hollow rod of a predetermined length with the addition of reinforcing material into the center of the hollow rod. The reinforcing material is preferably a polymer material.

The result is a relatively lightweight rod which is also of optimum strength due to the polymer inner core. This method is faster and less expensive than boring solid rods or plugging hollow ones and has mechanical properties superior thereto.

It is to be understood that in this specification, reference to a rod is to be construed as including long members of any cross section, circular or ellipse, etc. Moreover, although reference is made herein to an at least partly filled hollow, generally thin-walled rod or plastic tubing, a portion of the hollow rod also can be filled with heavier metal to counter balance the implement.

Other features and advantages of the present invention will become apparent from the following detailed description taken in conjunction with the accompanying drawings, which illustrate, by way of example, the principles of the invention.

### BRIEF DESCRIPTION OF THE DRAWINGS

FIG. 1 is a perspective view of the present invention in use as a shovel handle.

FIG. 2 is a perspective view of the present invention in use as a shovel handle having graduations thereon.

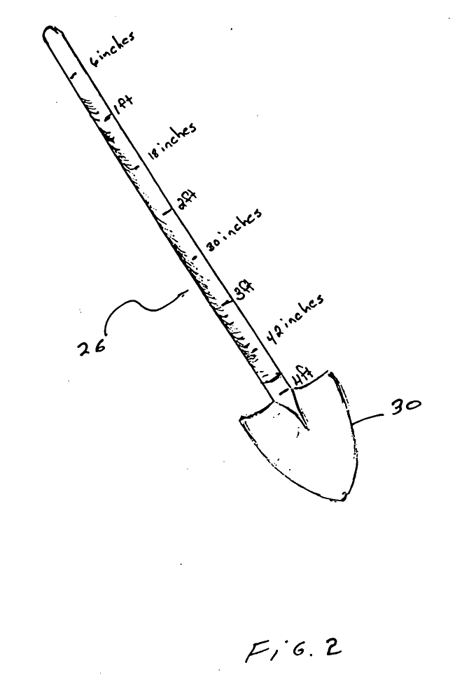

### DETAILED DESCRIPTION

The present invention is embodied in a plastic or composite rod with a hollow cross-section, and a method for its production.

The conventionally pultruded solid rod is too heavy for some applications, such as shovel handles. At the same time, the conventionally pultruded hollow rod is too weak at high stress points for some of these same applications. With a modification of either method, involving boring out the solid rod or plugging the hollow rod, it is possible to produce a reinforced hollow rod using conventional techniques, but both methods have major drawbacks including high cost and lowered strength.

In accordance with the present invention, a hollow plastic or composite handle 26 having reinforcing material 24 at least partly filling the hollow portion is formed. The end product of this invention is relatively strong due to the reinforcing material.

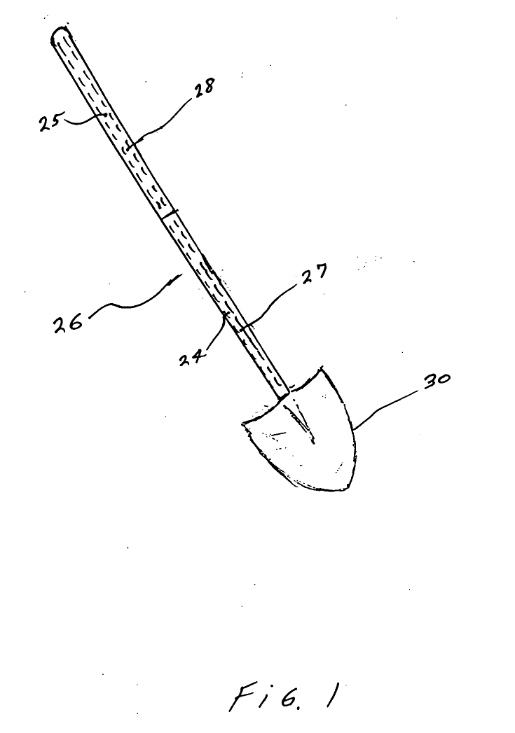

FIG. 1 shows the present invention for use as a shovel handle 26 having a hollow interior 25. The hollow interior 25 is at least partly filled with a polymer. Advantageously the shovel can be counterbalanced by filling the lower portion 27 of hollow interior 25 with a polymer and at least partly filling the upper portion 28 with a heavier material thereby reinforcing handle 26. The lower portion of handle 26 is inserted into a socket of a shovel blade 30. The portion of the handle 26 that is inserted into the socket can be retained therein by a rivet, through a bolt or any other conventional means used for retaining handles in contact within an implement.

If desired, a conventional grip can be secured onto the opposite end of the handle 26 by an adhesive or any other conventional means. As mentioned above, the handle can be counterbalanced by filling a portion of the hollow space opposite the blade with heavier material. Of particular advantage in some working environments the handle of the present invention along with an attached implement will float on water or other liquid where the density of the polymer used to fill the hollow portion of the handle is controlled within certain parameters.

The present invention relates to a generally elongated hollow reinforced tool handle having a predetermined length, said tool handle comprising reinforcing material extending within and at least partly filling the hollow handle along a first portion of said predetermined length and reinforcing material extending within and at least partly filling a second portion of said length, said first portion located in the length of said handle that is intended to attach to an implement and said second portion being located in the length of said handle opposite the portion that attaches to an implement. Advantageously the hollow tool handle is formed of plastic or a fiber-resin composite. Advantageously the fiber-resin composite is fiberglass. The reinforcing material is advantageously a polymer material. The first portion of the handle may be filled with polystyrene. Advantageously both the first and second reinforcing portions are filled with polystyrene. Advantageously both the first and second reinforcing portions are filled with foamed polystyrene. Preferably said first reinforcing portion is filled with a material having a certain weight and said second reinforcing portion is filled with a material having a weight greater than the weight of the material in said first reinforcing portion. Most preferably said first reinforcing portion is filled with a polymer and said second reinforcing section is filled with a material selected from the group consisting of metals, sand, gravel, concrete, and combinations thereof.

The present invention is also directed to a method for producing a hollow reinforced tool handle, said method comprising the steps of forming a hollow rod-like handle of a plastic or composite material, and at least partly filling said hollow-portion with a polymer material. Advantageously the hollow rod-like handle has a lower interior section and an upper interior section. Most advantageously said lower section and said upper section are at least partly filled with a polymer material. Preferably said polymer material is polystyrene or foamed polystyrene. Most preferably said upper section is filled with a material weighing more than the material which fills said lower section. Particularly preferred said upper section is filled with a material selected from the group consisting of metals, sand, gravel, concrete, and combinations thereof.

In accordance with the various features of this invention, an improved graduated tool handle is also provided. The improved graduated tool handle is suitable for use with various tools including, but not limited to, post-hole diggers, rakes, shovels, hoes and concrete rakes. The improved tool handle is graduated so as to indicate feet and inches and fractions thereof. In the preferred embodiment, the graduations are identified such that the measurements are taken from the proximal end of the tool, (it being understood that the distal end provides the point of attachment for the blade of the tool). In the preferred embodiment, the tool handle is circumferentially graduated in 6″ markings, with feet and half-foot dimensions identified with readily visible indicia on each side of the handle. In this fashion, the markings and indicia are readily visible from substantially any point of reference around the handle.

The improved tool handle of the present invention may include an elongated handle member having a proximal end adapted for gripping and a distal end adapted for receiving an implement wherein said elongated handle member has a selected geometric cross-section; a plurality of graduations defining units of linear measure carried by said elongated handle; and indicia carried by said handle, wherein said indicia is associated with said graduations and identifies selected units of measurement.

While a particular form of the invention has been illustrated and described, it will be apparent that various modifications can be made without departing from the spirit and scope of the invention. Accordingly, the invention is not to be limited, except as by the appended claims.

1. A generally elongated hollow reinforced tool handle having a predetermined length, said tool handle comprising:
reinforcing material extending within and at least partly filling the hollow handle along a first portion of said predetermined length and reinforcing material extending within and at least partly filling a second portion of said length, said first portion located in the length of said handle that is intended to attach to an implement and said second portion being located in the length of said handle opposite the portion that attaches to an implement.

2. The reinforced tool handle as set forth in claim 1 wherein the hollow tool handle is formed of plastic.

3. The reinforced tool handle as set forth in claim 1 wherein the hollow tool handle is formed of a fiber-resin composite.

4. The reinforced tool handle as set forth in claim 3 wherein the fiber-resin composite is fiberglass.

5. The reinforced tool handle as set forth in claim 1 wherein said reinforcing material is a polymer material.

6. The reinforced tool handle as set forth in claim 5 wherein the first portion is filled with polystyrene.

7. The reinforced tool handle as set forth in claim 5 wherein both the first and second reinforcing portions are filled with polystyrene.

8. The reinforced tool handle as set forth in claim 5 wherein both the first and second reinforcing portions are filled with foamed polystyrene.

9. A reinforced tool handle as set forth in claim 1 wherein said first reinforcing portion is filled with a material having a certain weight and said second reinforcing portion is filled with a material having a weight greater than the weight of the material in said first reinforcing portion.

10. The reinforced tool handle as set forth in claim 9 wherein said first reinforcing portion is filled with a polymer and said second reinforcing section is filled with a material selected from the group consisting of metals, sand, gravel, concrete, and combinations thereof.

11. A method for producing a hollow reinforced tool handle, said method comprising the steps of forming a hollow rod-like handle of a plastic or composite material, wherein the hollow rod-like handle has a lower interior section and an upper interior section and at least partly filling said hollow-portions with a polymer material.

12. (canceled)

13. The method of claim 11 wherein said lower section and said upper section are at least partly filled with a polymer material.

14. The method of claim 13 wherein said polymer material is polystyrene.

15. The method of claim 14 wherein said polymer material is foamed polystyrene.

16. The method of claim 11 wherein said upper section is filled with a material weighing more than the material which fills said lower section.

17. The method of 16 wherein said upper section is filled with a material selected from the group consisting of metals, sand, gravel, concrete, and combinations thereof.

18. An improved, generally elongated hollow reinforced tool handle having a predetermined length, said tool handle comprising:
reinforcing material extending within and at least partly filling the hollow handle along a first portion of said predetermined length and reinforcing material extending within and at least partly filling a second portion of said length, said first portion located in the length of said handle that is intended to attach to an implement and said second portion being located in the length of said handle opposite the portion that attaches to an implement
wherein the elongated handle has a proximal end adapted for gripping and a distal end adapted for receiving an implement and wherein said elongated handle has a selected geometric cross-section;
a plurality of graduations defining units of linear measure carried by said elongated handle; and
indicia carried by said handle, wherein said indicia is associated with said graduations and identifies selected units of measurement.
